(19) United States
(12) Patent Application Publication
(10) Pub. No.: US 2016/0056443 A1
(43) Pub. Date: Feb. 25, 2016

(54) APPARATUS FOR AND METHOD OF PREVENTING DISCHARGE OF BATTERY FOR AUTOMOBILE

(71) Applicant: SAMSUNG ELECTRO-MECHANICS CO., LTD., Suwon-Si (KR)

(72) Inventors: Gyoung Tai KIM, Suwon-Si (KR); Joon Sik SHIN, Suwon-Si (KR); Joung Ho SON, Suwon-Si (KR); Sung Jun LEEM, Suwon-Si (KR)

(73) Assignee: SAMSUNG ELECTRO-MECHANICS CO., LTD., Suwon-Si (KR)

(21) Appl. No.: 14/661,198

(22) Filed: Mar. 18, 2015

(30) Foreign Application Priority Data
Aug. 20, 2014 (KR) 10-2014-0108172

(51) Int. Cl. H01M 2/34; B60K 35/00

(52) U.S. Cl. CPC H01M 2/34; B60K 35/00; H01M 2220/20; H01M 2200/00

(57) ABSTRACT

An apparatus for preventing discharge of a battery for an automobile includes a cleaner driven using the battery for an automobile, a rotation sensing unit sensing a rotation speed of the cleaner, and a controlling unit receiving information on the rotation speed of the cleaner from the rotation sensing unit and transmitting a signal externally. Whether or not the cleaner is driven is controlled in response to a driving signal of the controlling unit.

### CROSS-REFERENCE TO RELATED APPLICATION

This application claims the priority and benefit of Korean Patent Application No. 10-2014-0108172 filed on Aug. 20, 2014, with the Korean Intellectual Property Office, the disclosure of which is incorporated herein by reference.

### BACKGROUND

The present disclosure relates to an apparatus for and a method of preventing discharge of a battery for an automobile.

Generally, a cleaner provided in order to clean an inner portion of an automobile, a battery driven type cleaner, uses power of a battery provided in the automobile engine when cleaning the inner portion of the automobile during a period in which the automobile is stopped.

Since the cleaner for an automobile described above uses the battery provided in the automobile, a time for which the cleaner can be used is limited, and in a case in which the cleaner is used for a long period of time, battery charge may be lowered, such that a problem due to discharge may occur.

Therefore, research into an apparatus capable of preventing discharge of a battery in the case in which the cleaner for an automobile is used is required.

### SUMMARY

An aspect of the present disclosure may provide an apparatus for and a method of preventing discharge of a battery for an automobile, capable of informing a user that a voltage of the battery is lowered in a case in which the voltage of the battery is lowered due to the use of a cleaner for an automobile.

An aspect of the present disclosure may also provide an apparatus for and a method of preventing discharge of a battery for an automobile capable of stopping driving of a cleaner for an automobile in a case in which a voltage of the battery is maintained at a preset voltage or less for a predetermined time.

According to an aspect of the present disclosure, an apparatus for preventing discharge of a battery for an automobile may include a cleaner driven using the battery for an automobile, a rotation sensing unit sensing a rotation speed of the cleaner, and a controlling unit receiving information on the rotation speed of the cleaner from the rotation sensing unit and transmitting a signal externally, wherein whether or not the cleaner is driven is controlled in response to a driving signal of the controlling unit.

The controlling unit may determine whether or not the rotation speed of the cleaner is decreased to a rotation limitation speed or less, and may transmit a signal to a discharge warning unit when the rotation speed of the cleaner is equal to the rotation limitation speed or less.

Therefore, when a voltage of the battery for an automobile is reduced, the controlling unit may transmit the signal to the discharge warning unit to inform a user of a discharge state of the battery.

In addition, the controlling unit may wait for or stop the driving of the cleaner when the rotation speed of the cleaner is equal to the rotation limitation speed or less, thereby preventing the battery for an automobile from being discharged.

According to another aspect of the present disclosure, a method of preventing discharge of a battery for an automobile may include determining a rotation speed of a cleaner for an automobile, transmitting the determined rotation speed to a controlling unit, determining whether or not the rotation speed received by the controlling unit is a rotation limitation speed or less, and transmitting a signal to a discharging warning unit when the rotation speed received by the controlling unit is equal to the rotation limitation speed or less.

The controlling unit may wait for or stop driving of the cleaner when the rotation speed of the cleaner is equal to the rotation limitation speed or less.

Therefore, the controlling unit may inform a user of a discharge state of the battery for an automobile and may prevent charge of the battery for an automobile from being excessively discharged.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a block diagram schematically illustrating an apparatus for preventing discharge of a battery for an automobile according to an exemplary embodiment of the present disclosure;

FIG. 2 is a flow chart illustrating an operation process of the apparatus for preventing discharge of a battery for an automobile according to the exemplary embodiment of the present disclosure; and

FIG. 3 is a flow chart of a method of preventing discharge of a battery for an automobile according to another exemplary embodiment of the present disclosure.

### DETAILED DESCRIPTION

Exemplary embodiments of the present disclosure will now be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements maybe exaggerated for clarity, and the same reference numerals will be used throughout to designate the same or like elements.

Meanwhile, an apparatus 500 for preventing discharge of a battery for an automobile according to an exemplary embodiment of the present disclosure may be applied to various electronic devices using a motor. Hereinafter, a case in which an apparatus 500 for preventing discharge of a battery for an automobile according to an exemplary embodiment of the present disclosure is applied to a cleaner for an automobile will be described.

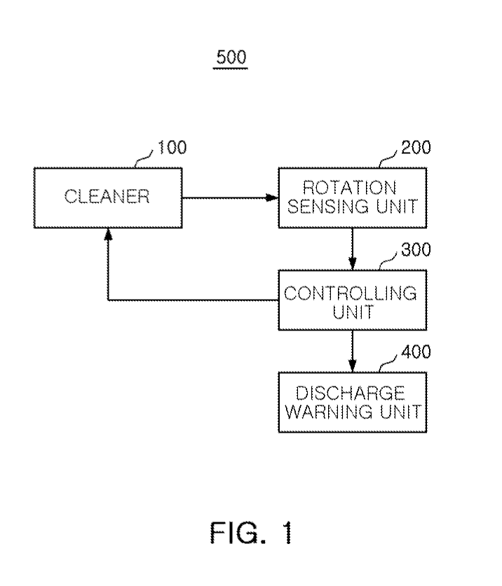

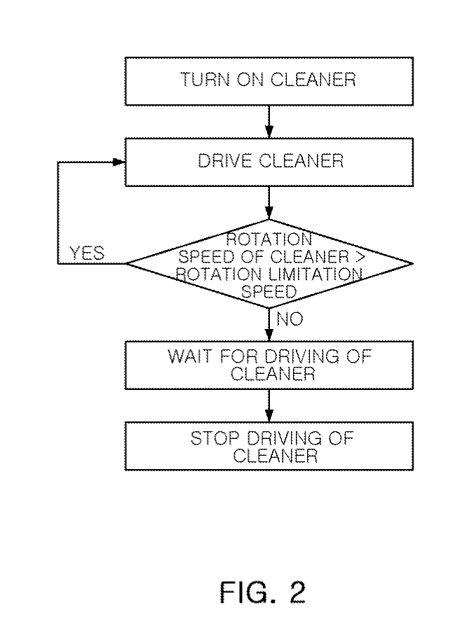

FIG. 1 is a block diagram schematically illustrating an apparatus for preventing discharge of a battery for an automobile according to an exemplary embodiment of the present disclosure; and FIG. 2 is a flow chart illustrating an operation process of the apparatus for preventing discharge of a battery for an automobile according to the exemplary embodiment of the present disclosure.

Referring to FIGS. 1 and 2, the apparatus for preventing discharge of a battery for an automobile according to the exemplary embodiment of the present disclosure may include a rotation sensing unit 200 sensing a rotation speed of a cleaner 100, a controlling unit 300, and a discharge warning unit 400.

The cleaner 100, which is mainly provided in order to clean an inner portion of the automobile, may be driven using power of the battery embedded in the automobile.

That is, the cleaner 100 provided in the automobile, which is a battery driven type cleaner, may be to clean the inner portion of the automobile, and may use the power of the battery embedded in the automobile.

The cleaner may be a vacuum cleaner, which performs cleaning using a pressure difference of air.

That is, the cleaner 100 may rotate a propeller provided therein to emit air therein externally and make an inner portion thereof a vacuum state.

Here, when internal pressure of the cleaner 100 is decreased, suction force may be generated, and external air pressure generated due to weight of the atmosphere may be higher than the internal pressure of the cleaner 100.

Due to this pressure difference, dust and a contaminant may be sucked together with the air into the cleaner of which pressure is low.

Meanwhile, a motor for rotating the propeller may be provided in the cleaner 100. As the motor provided in the cleaner 100, various motors may be used depending on installation environments and requirements. As an example, a brushless motor may be used.

Generally, the motor may be a power unit converting electrical energy into kinetic energy, and may be configured so that a rotor rotates with respect to a stator by an electromagnetic induction phenomenon of the stator and the rotor.

In addition, the motor may include a permanent magnet type or non-magnet type rotor, include a core and a winding coil installed in the stator, and have a structure in which it is operated by supplying electricity to a commutator provided in the rotor from the stator through a brush.

However, since friction is repeatedly generated between the commutator and the brush during an operation of the motor, durability of the motor maybe decreased, and energy conversion efficiency may be relatively decreased.

Therefore, the cleaner 100 according to the exemplary embodiment of the present disclosure may use a brushless motor in order to complement the above-mentioned problems. The brushless motor may have a configuration in which a permanent magnet type or non-magnet type rotor is provided as the rotor and the core and the winding coil are provided in the stator, such that the brush and the commutator are not required.

However, the apparatus 500 for preventing discharge of a battery for an automobile according to the exemplary embodiment of the present disclosure is not necessarily limited to being applied to the cleaner for an automobile using the brushless motor.

That is, the apparatus 500 for preventing discharge of a battery for an automobile according to the exemplary embodiment of the present disclosure may also be applied to a device using various kinds of motors, which falls within the scope of the present disclosure.

The cleaner 100 may include a pressure sensor (not illustrated) provided therein. The pressure sensor, which is provided in order to determine whether or not the cleaner 100 is driven, may transmit information on whether or not the cleaner is driven to a controlling unit 300 to be described below.

That is, the apparatus 500 for preventing discharge of a battery for an automobile according to the exemplary embodiment of the present disclosure may determine a rotation speed of the cleaner 100 to determine whether or not the battery for an automobile is discharged, which is to prevent an error that the controlling unit 300 determines that the battery is discharged in a case in which the rotation speed of the cleaner 100 is decreased due to a reason other than the discharge of the battery, for example, foreign materials caught into an inlet of the cleaner.

Here, a process in which the pressure sensor provided in the cleaner 100 determines whether or not the cleaner 100 is driven will be briefly described. First, when the cleaner 100 is a stop state, internal pressure of the cleaner 100 may be maintained in a state in which it is the same as external atmospheric pressure.

On the other hand, when the cleaner 100 is driven, the motor provided in the cleaner 100 may rotate to make an inner portion of the cleaner 100 a vacuum state. Therefore, when the cleaner 100 is being driven, the internal pressure of the cleaner may be maintained as pressure lower than the external atmospheric pressure.

In addition, also in a case in which the foreign materials are caught into the inlet, the internal pressure of the cleaner may be changed.

The pressure sensor may determine the change in the internal pressure of the cleaner to transmit information on an operation state of the cleaner to the controlling unit 300, and the controlling unit 300 may determine whether or not the battery provided in the automobile is discharged based on this information.

In addition, since components other than the components of the cleaner 100 described above, for example, a suction device, a housing, and the like, are obvious to those skilled in the art, a detailed description therefor will be omitted.

Meanwhile, the cleaner 100 may be electrically and physically connected to the rotation sensing unit 200 for determining the rotation speed of the cleaner 100.

Here, various kinds of rotation sensing units may be used as the rotation sensing unit 200 as long as they may sense a rotation speed of the motor provided in the cleaner 100.

The rotation sensing unit 200 may sense the rotation speed of the motor when the cleaner 100 is being driven and transmit information on the rotation speed of the cleaner 100 to the controlling unit 300.

As described below, the controlling unit 300 may determine whether or not the battery for an automobile is discharged based on the information on the rotation speed of the cleaner 100 received from the rotation sensing unit 200 and the information on whether or not the cleaner is driven, received from the pressure sensor.

That is, in the case in which the cleaner 100 is driven, the rotation sensing unit 200 may sense the rotation speed of the motor in real time and transmit the information on the rotation speed to the controlling unit 300, and the controlling unit 300 may determine whether or not the received rotation speed is decreased to a preset rotation speed (that may mean a rotation speed of the cleaner just before the battery for an automobile is in a discharge state, and will be referred to as a rotation limitation speed) or less.

In addition, the controlling unit 300 may check a driving state of the cleaner 100 from the pressure sensor to confirm whether or not the battery for an automobile is discharged.

The controlling unit 300 may receive the information on the rotation speed of the cleaner 100 from the rotation sensing unit 200 and transmit a signal externally.

That is, the controlling unit 300 may determine whether or not the battery for an automobile is discharged based on the information on the rotation speed of the cleaner 100 received from the rotation sensing unit 200 and the information on whether or not the cleaner is driven, received from the pressure sensor, and finally control the driving of the cleaner 100 or activate the discharge warning unit 400.

An operation of the controlling unit 300 will be described. In the case in which the cleaner 100 is driven, the rotation sensing unit 200 may sense the rotation speed of the cleaner 100 in real time and transmit the information on the rotation speed to the controlling unit 300.

Here, when power of the battery for an automobile is sufficient, the cleaner 100 may be driven while maintaining a specific rotation speed or more.

Meanwhile, since the cleaner 100 is driven while continuously consuming the power of the battery for an automobile and the rotation speed of the cleaner 100 is affected by the power of the battery, in a case in which the power of the battery is decreased, the rotation speed of the cleaner 100 may also be decreased.

Here, in a case in which the rotation speed of the cleaner 100 arrives at the rotation limitation speed, the controlling unit 300 may check a driving state of the cleaner 100 based on a signal received from the pressure sensor.

That is, when the rotation speed of the cleaner 100 arrives at the rotation limitation speed even though the driving state of the cleaner 100 is normal, the controlling unit 300 may transmit signals to a discharge warning unit 400 to be described below and the cleaner 100.

Here, the controlling unit 300 may transmit the signals to the discharge warning unit 400 in each process in which the rotation speed of the cleaner 100 is decreased as well as in the case in which the rotation speed of the cleaner 100 arrives at the rotation limitation speed.

As an example, processes of the rotation speeds such as a case in which the rotation speed of the cleaner 100 is 100 to 80% of a rotation speed of the cleaner 100 in a state in which the battery is completely charged, a case in which the rotation speed of the cleaner 100 is 80 to 60% of the rotation speed of the cleaner 100 in a state in which the battery is completely charged, and the like, may be determined, and the signals may be transmitted to the discharge warning unit 400.

Here, the above-mentioned process ranges of the rotation speed may be variously changed, if necessary.

The discharge warning unit 400 may include a lamp or a speaker to generate a warning light or a warning sound, thereby informing a user that the battery is in a discharge risk state.

However, the discharge warning unit 400 is not limited to the lamp or the speaker, but may be any unit that may warn the user that the battery is in the discharge risk state.

At the same time, the controlling unit 300 may wait for the driving of the cleaner 100. Here, waiting for the driving of the cleaner 100 means that only minimum power is transferred to the cleaner 100 so that power may be maintained in the cleaner 100 without performing a suction function of the cleaner 100.

Then, in a case in which a driving waiting time of the cleaner 100 exceeds a preset time, the controlling unit may stop the driving of the cleaner 100 to prevent the battery for an automobile from being discharged.

That is, the apparatus 500 for preventing discharge of a battery for an automobile according to the exemplary embodiment of the present disclosure may sense the rotation speed of the cleaner 100, inform the user of a state of the battery for an automobile through the discharge warning unit 400 in a case in which the battery for an automobile is in a state in which it may be discharged, and stop the driving of the cleaner 100, thereby preventing the battery for an automobile from being discharged.

Therefore, various problems that occur due to the discharge of the battery for an automobile may be prevented.

The discharge warning unit 400 may receive the signal transmitted from the controlling unit 300 and display whether or not the battery is discharged.

That is, as described above, the controlling unit 300 may transmit the signal to the discharge warning unit 400 to activate the discharge warning unit 400, in a case in which the battery is in the state in which it may be discharged based on the rotation speed and the driving state of the cleaner 100.

Here, the discharge warning unit 400 may include at least one speaker. Therefore, in a case in which the discharge warning unit 400 receives the signal from the controlling unit 300, the discharge warning unit 400 may generate a warning sound.

That is, when the warning sound is generated, the user may recognize that the battery for an automobile is currently in the discharge risk state from the warning sound.

Furthermore, the discharge warning unit 400 may also include at least one lamp.

Therefore, in the case in which the discharge warning unit 400 receives the signal from the controlling unit 300, the discharge warning unit 400 may generate a warning light, and the user may view the warning light to recognize a current state of the battery for an automobile.

Here, the controlling unit 300 may transmit signals to the discharge warning unit 400 in each process of the rotation speed.

Therefore, in a case in which the discharge warning unit 400 includes the at least one speaker, the discharge warning unit 400 may generate different warning sounds in each process of the rotation speed.

In addition, in a case in which the discharge warning unit 400 includes the at least one lamp, the discharge warning unit 400 may generate different warning lights in each process of the rotation speed.

Further, the discharge warning unit 400 may include both of at least one speaker and at least one lamp.

That is, the discharge warning unit 400 may include a combination of the speaker and the lamp, if structurally necessary or necessary in terms of a design.

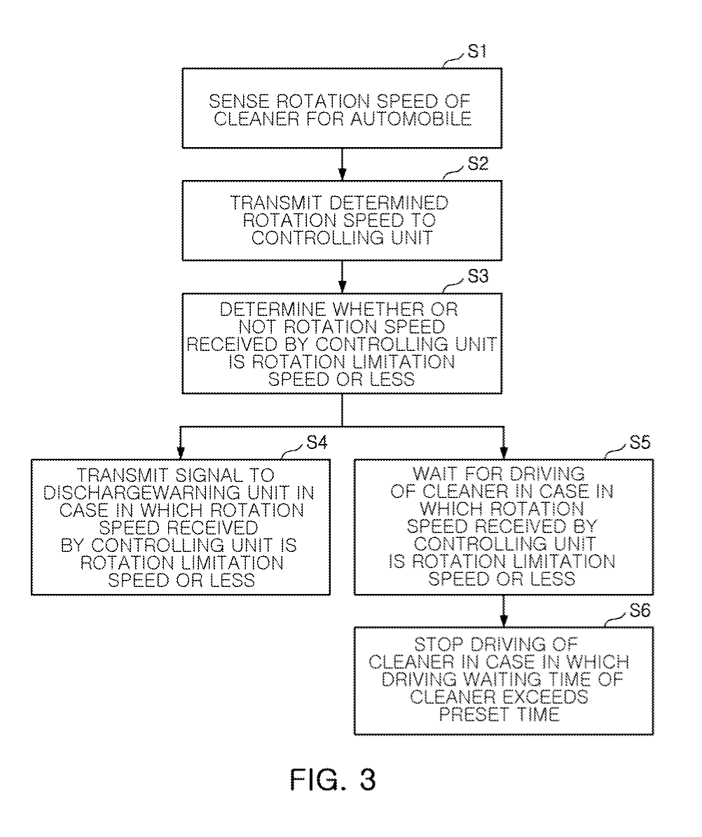

FIG. 3 is a flow chart of a method of preventing discharge of a battery for an automobile according to another exemplary embodiment of the present disclosure.

Referring to FIG. 3, the method of preventing discharge of a battery for an automobile according to another exemplary embodiment of the present disclosure may include determining the rotation speed of the cleaner 100 for an automobile (S1), transmitting the determined rotation speed to the controlling unit 300 (S2), determining whether or not the rotation speed received by the controlling unit 300 is equal to the rotation limitation speed or less (S3), and transmitting the signal to the discharge warning unit (S4) in the case in which the rotation speed received by the controlling unit 300 is equal to the rotation limitation speed or less.

The determining (S1) of the rotation speed of the cleaner 100 for an automobile, which is a process of detecting the rotation speed of the cleaner 100 that is being driven, may be performed by the rotation sensing unit 200. That is, the rotation sensing unit 200 may be electrically connected to the cleaner 100 to sense the rotation speed of the motor in real time when the cleaner is being driven.

Then, the transmitting (S2) of the determined rotation speed to the controlling unit 300 and the determining (S3) of whether or not the rotation speed received by the controlling unit 300 is equal to the rotation limitation speed or less may be performed.

In the case in which the power of the battery for an automobile is sufficient, the cleaner 100 may be driven while maintaining the specific rotation speed or more.

Meanwhile, since the cleaner 100 is driven while continuously consuming the power of the battery for an automobile and the rotation speed of the cleaner 100 is affected by the power of the battery, in the case in which the power of the battery is decreased, the rotation speed of the cleaner 100 may also be decreased.

Therefore, when the rotation speed of the cleaner 100 arrives at the rotation limitation speed even though the driving state of the cleaner 100 is normal, it means that the battery is in the discharge state.

In a case in which the rotation speed received by the controlling unit 300 is equal to the rotation limitation speed or less in the determining (S3) of whether or not the rotation speed received by the controlling unit 300 is equal to the rotation limitation speed or less, the transmitting (S4 and S5) of the signal to at least one of the discharge warning unit 400 and the cleaner 100 may be performed.

That is, in the case in which the rotation speed of the cleaner 100 arrives at the rotation limitation speed, it means that the battery for an automobile is in a state just before it is discharged. Therefore, the controlling unit 300 may transmit the signal to the discharge warning unit 400.

The discharge warning unit 400, which receives the signal transmitted from the controlling unit 300 to display whether or not the battery is discharged, includes the speaker or the lamp to generate the warning sound or the warning lamp, thereby informing the user that the battery for an automobile is in the discharge risk state.

In addition, in the case in which the rotation speed received by the controlling unit 300 is equal to the rotation limitation speed or less, a process (S5) of waiting for the driving of the cleaner 100 may be performed. Here, in the case in which the driving waiting time of the cleaner exceeds a predetermined time, a process (S6) of stopping the driving of the cleaner 100 may be performed.

As set forth above, in the apparatus and the method of preventing discharge of a battery for an automobile according to the exemplary embodiments of the present disclosure, the discharge of the battery for an automobile when the cleaner is being used may be prevented.

While exemplary embodiments have been shown and described above, it will be apparent to those skilled in the art that modifications and variations could be made without departing from the scope of the present invention as defined by the appended claims.

What is claimed is:

1. An apparatus for preventing discharge of a battery for an automobile, comprising:
a rotation sensing unit sensing a rotation speed of a cleaner; and
a controlling unit receiving information on the rotation speed of the cleaner from the rotation sensing unit and transmitting a signal externally,
wherein whether or not the cleaner is driven is controlled in response to a driving signal of the controlling unit.

2. The apparatus for preventing discharge of a battery for an automobile of claim 1, wherein the controlling unit determines whether or not the rotation speed of the cleaner is decreased to a rotation limitation speed or less.

3. The apparatus for preventing discharge of a battery for an automobile of claim 2, wherein the controlling unit transmits a signal to a discharge warning unit displaying whether or not the battery is discharged when the rotation speed of the cleaner is equal to the rotation limitation speed or less.

4. The apparatus for preventing discharge of a battery for an automobile of claim 2, wherein the controlling unit waits for the driving of the cleaner when the rotation speed of the cleaner is equal to the rotation limitation speed or less.

5. The apparatus for preventing discharge of a battery for an automobile of claim 4, wherein the driving of the cleaner is stopped when a driving waiting time of the cleaner exceeds a preset time.

6. The apparatus for preventing discharge of a battery for an automobile of claim 3, wherein the discharge warning unit includes at least one speaker and generates a warning sound when the discharge warning unit receives the signal from the controlling unit.

7. The apparatus for preventing discharge of a battery for an automobile of claim 3, wherein the discharge warning unit includes at least one lamp and generates a warning light when the discharge warning unit receives the signal from the controlling unit.

8. The apparatus for preventing discharge of a battery for an automobile of claim 1, wherein the cleaner is driven by a brushless motor.

9. The apparatus for preventing discharge of a battery for an automobile of claim 1, wherein the cleaner is provided with a pressure sensor determining whether or not the cleaner is driven.

10. A method of preventing discharge of a battery for an automobile, comprising:
determining a rotation speed of a cleaner for an automobile;
transmitting the determined rotation speed to a controlling unit;
determining whether or not the rotation speed received by the controlling unit is a rotation limitation speed or less; and
transmitting a signal externally when the rotation speed received by the controlling unit is equal to the rotation limitation speed or less.

11. The method of preventing discharge of a battery for an automobile of claim 10, wherein in the transmitting of the signal externally, the signal is transmitted from the controlling unit to a discharging warning unit.

12. The method of preventing discharge of a battery for an automobile of claim 10, wherein in the transmitting of the signal externally, the controlling unit transmits the signal to the cleaner to wait for driving of the cleaner.

13. The method of preventing discharge of a battery for an automobile of claim 12, further comprising stopping the driving of the cleaner when a driving waiting time of the cleaner exceeds a preset time.

14. The method of preventing discharge of a battery for an automobile of claim 11, wherein the discharging warning unit includes a speaker or a lamp to generate a warning sound or a warning light when the discharging warning unit receives the signal from the controlling unit.
